(19) United States
(12) Patent Application Publication
(10) Pub. No.: US 2016/0299352 A1
(43) Pub. Date: Oct. 13, 2016

(54) Detachable hinge for spectacle frame

(71) Applicants: Wen Jie Dai, Hong Kong (CN); Tony Xin Xiao, Chino, CA (US)

(72) Inventors: Wen Jie Dai, Hong Kong (CN); Tony Xin Xiao, Chino, CA (US)

(21) Appl. No.: 14/545,201

(22) Filed: Apr. 7, 2015

(51) Int. Cl. G02C 5/22; G02C 5/14

(52) U.S. Cl. CPC G02C 5/2209; G02C 5/146; G02C 2200/08

(57) ABSTRACT

A detachable hinge for spectacle frame connecting between a temple portion and an end-piece portion comprises a connecting mean and a locking mean, wherein the connecting mean includes a cylindrical connecting member that extends from a cuboid connecting member which is connected to the temple portion; and the locking mean includes a vertical slot for overlapping a vertical hole which is formed on the top of the locking mean for receiving the connecting members. When the connecting mean is being inserted into the locking mean, the cylindrical connecting member is able to rotate inside of the vertical locking hole while the vertical slot prevents the cylindrical connecting member sliding out from the vertical locking hole, so as to form a detachable hinge.

### BACKGROUND OF THE PRESENT INVENTION

1. Field of Invention

The present invention relates to a spectacle frame, and more particular to a detachable hinge for connecting between an end-piece portion and a temple portion of spectacle frame, wherein the detachable hinge is adapted for detachably coupling the temple portion of spectacle frame for exchangeable purpose.

2. Description of Related Arts

3. Invention Background

The original use and intentions for eyeglasses may have been medical, but they are now elevated far beyond simple vision correction. They are now selected for beauty, and for the wearer's uniqueness. As myopia becomes far more common in younger generations, glasses are becoming an integral part of people's life, and personality.

The temple of the glasses is perhaps the most important component of any pair, as it can change the style and fashion of the glasses as a whole.

Why temples need to be replaced, detached, or exchanged?

Temples are typically made of metal or plastic, leaving them vulnerable to damage by corrosion due to sweat, or by aging of the material. Because of this, the temples are perhaps the easiest part of the glasses to ruin. A full pair of glasses is expensive, so if the wearer can get the temples replaced separately, he or she can save a lot of money.

Massive demand for fashion has driven prices for fashionable goods through the roof, and glasses are no exception. So, if a wearer needs different glasses for different occasions or outfits, multiple pairs can be very expensive. However, if the temples are interchangeable, these needs are met, and a lot of money is saved in the process.

Wearers aren't typically able to replace the temple on their own because most pairs of glasses have a screw in the hinge of the temple, and this screw is typically very difficult to remove and replace. Without a skilled professional, the temples could be ruined. Even opticians sometimes run into difficulty removing temples.

Interchangeable temples solve this problem easily, as they have a detachable hinge connected between an end-portion and temple portion of the glasses' frame. With this detachable hinge, the temple is very easily removed and reattached, without needing professional skill. Typically, tools aren't even needed. Thus, detachable temple hinges make replacing and changing temples a very easy task.

### SUMMARY OF THE PRESENT INVENTION

The main object of the present invention is to provide a detachable hinge for spectacle frame connecting between an end-piece portion and a temple portion of the spectacle frame, wherein the detachable hinge comprises a locking mean and a connecting mean which both are detachable, therefore, the temple portion of the spectacle can be easily detached and exchanged.

Another object of the present invention is to provide a detachable hinge, wherein the connecting mean has a cylindrical connecting member extending from the temple portion and the locking mean has a cylinder locking slot for receiving the connecting member from the connecting mean, when the connecting member is being inserted into the locking slot, the connecting member is able to rotate inside the locking slot, so as to form a detachable hinge.

According to the present invention, the foregoing and other objects and advantages are attained by a detachable hinge for spectacle frame, comprising:

A locking mean and a connecting mean, wherein the connecting mean includes a first connecting member and a second connecting member, the first connecting member is extended from the temple portion with cuboid structure, and the second connecting member is extended from the first connecting member with cylindrical structure; And the locking mean includes a locking slot and a horizontal slot, wherein the locking slot is formed by a vertical slot overlapping a vertical hole which is formed on top of the locking mean, wherein the vertical hole is extended downward to near the bottom of the locking mean, and the vertical slot is cut through the inner side of the locking mean.

And the horizontal slot is extended from the bottom of the vertical slot horizontally cutting through the end of the locking mean for receiving the first connecting member. When the connecting mean is faced perpendicular to the locking mean, the first and second connecting members are able to insert into the locking slot from the top of the locking mean, thereby the second connecting member can be coaxially rotated inside of the vertical hole while the vertical slot will prevent the second connecting member sliding out from the vertical hole and the wall of the horizontal slot will block the first connecting member for preventing the detachable hinge over rotation. Therefore the temple portion of the spectacle frame can be rotated or folded, and also with this detachable hinge, the temple is very easy to remove or reattach, without needing professional skill or any auxiliary tools.

### BRIEF DESCRIPTION OF THE DRAWINGS

FIG. 1 is a front perspective view of a spectacle frame according to the first preferred embodiment of the present invention.

FIG. 2 is an exploded perspective view of the detachable hinge according to the first preferred embodiment of the present invention.

FIG. 3 is a sectional view of the detachable hinge according to the first preferred embodiment of the present invention.

FIG. 4 is a side view of the detachable hinge according to the first preferred embodiment of the present invention.

FIG. 5 is an exploded perspective view of the detachable hinge according to the second preferred embodiment of the present invention.

FIG. 6 is a sectional view of the detachable hinge according to the second preferred embodiment of the present invention.

FIG. 7 is a side view of the detachable hinge according to the second preferred embodiment of the present invention.

### DETAILED DESCRIPTION OF THE PREFERRED EMBODIMENT

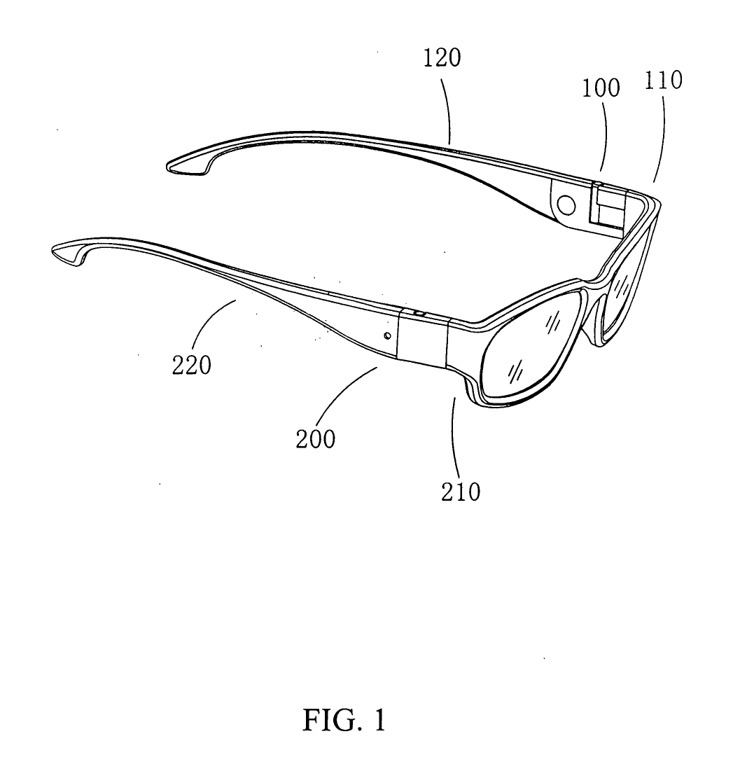

Referring to FIG. 1 of the drawing, two detachable hinge 100, 200 are connected between two end-piece portions 110, 210 and two temple portions 120, 220 of a spectacle frame respectively, wherein each detachable hinge can be easily detached and separated without using any auxiliary tools, so that two temple portions 120, 220 and two end-piece portions 110, 210 are able to achieve freely for the purpose of detachable and exchangeable from the chassis of the spectacle frame.

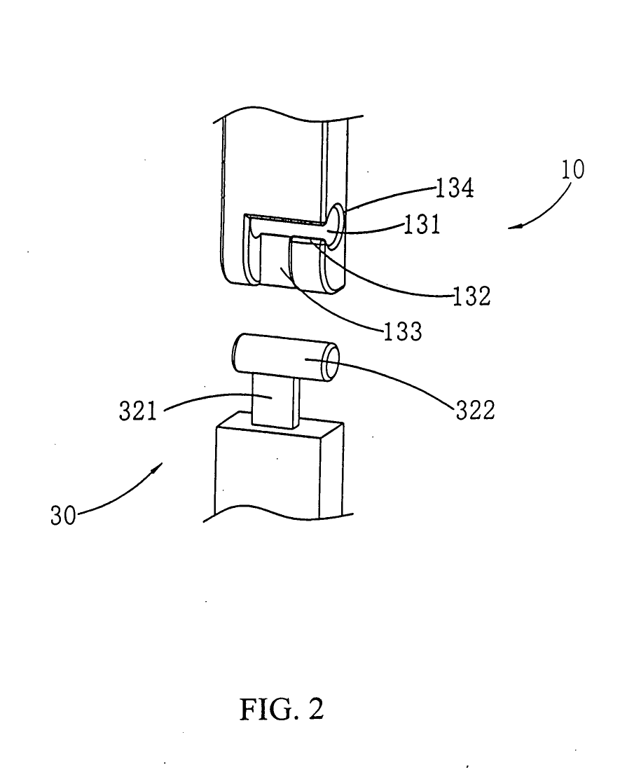

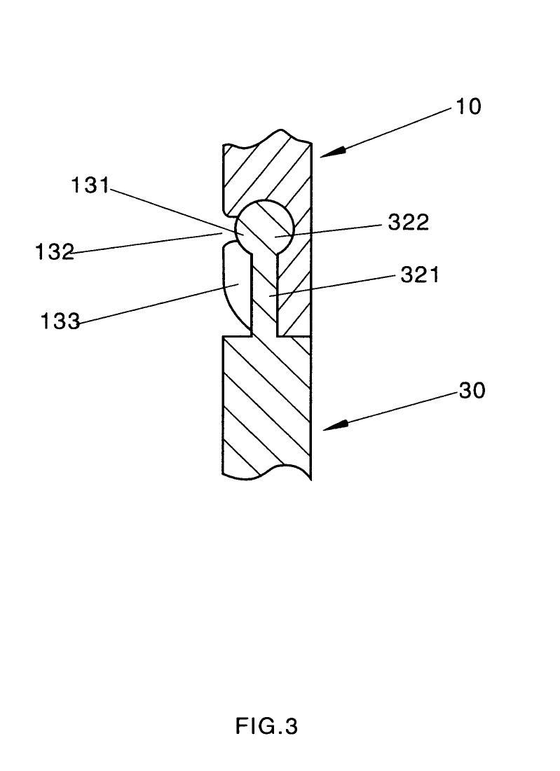

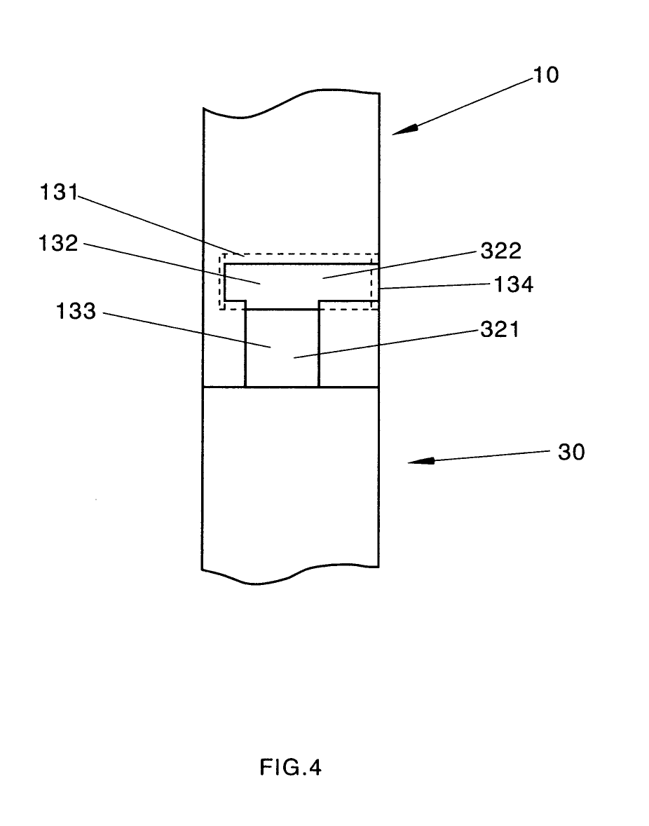

Specifically, as shown in FIG. 2 to FIG. 4, according to the first preferred embodiment of the present invention, the detachable hinge 100 comprises a locking mean 10 and a connecting mean 30, wherein the connecting mean 30 included a first connecting member 321 and a second connecting member 322. The first connecting member 321 is formed integrally extending from the end-piece portions 110, and the second connecting member 322 is extended from the first connecting member 321. Practically, the first connecting member 321 has a cuboid structure, and the second connecting member 322 has a cylindrical structure, the width of the first connecting member 321 is smaller than the diameter of the second connecting member 322. Moreover, the first connecting member 321 is coaxially aligned with the second connecting member 322.

On the other hand, the locking mean 10 is formed integrally extending from the temple portions 120, wherein the locking mean 10 includes a locking slot 134 and a horizontal slot 133, wherein the locking slot 134 is formed by a vertical slot 132 overlapping a vertical hole 131 which is formed on the top of the locking mean 10 and extended downwardly to near its bottom. Furthermore, the groove of the vertical slot 132 is open from the inner side of the locking mean 10 rather than from the outer side of the locking mean 10 for keeping good appearance of the detachable hinge from outside look as a regular hinge. In addition, the width of the vertical slot 132 is smaller than the diameter of the vertical hole 131, and the vertical slot 132 is coaxially aligned with the vertical hole 131. Moreover, the horizontal slot 133 is extended from the end of the vertical slot 132 cutting through the end of the locking mean 10 for receiving the first connecting member 321, and also the horizontal slot 133 is coaxially aligned with the vertical hole 131. It is worth to mention that while the size and shape of the first connecting member 321 and the second connecting member 322 are respectively matched to the size and shape of the horizontal slot 133 and the vertical hole 131 of the locking mean 10, so that when the connecting mean 30 is in a position perpendicular facing to the locking mean 10, the first and the second connecting members 321, 322 can be easily inserted into the locking slot 134 from the top of the locking mean 10, and the second connecting member 322 is able to rotate coaxially inside of the vertical hole 131 while the groove of the vertical slot 132 will prevent the second connecting member 322 sliding out from the vertical hole 131. And the wall of the horizontal slot 133 will block the first connecting member 321 over turn as well, so as to prevent the detachable hinge over rotation while the first connecting member 321 is concealed inside of the horizontal slot 133. In actual production, the rotation angle of the detachable hinge can be preset by presetting an angle between the second connecting 322 and the horizontal slot, when they are in the same line, the rotation angle will be in 90°. As the function mentioned above, the connecting mean 30 and the locking mean 10 are able to detach freely themselves. Therefore, the first preferred embodiment of the present invention, the temple portions of the spectacle frame can be easily attached, rotated, folded or detached, and the wearer is able to exchange the temple of the frame freely without using any auxiliary tools.

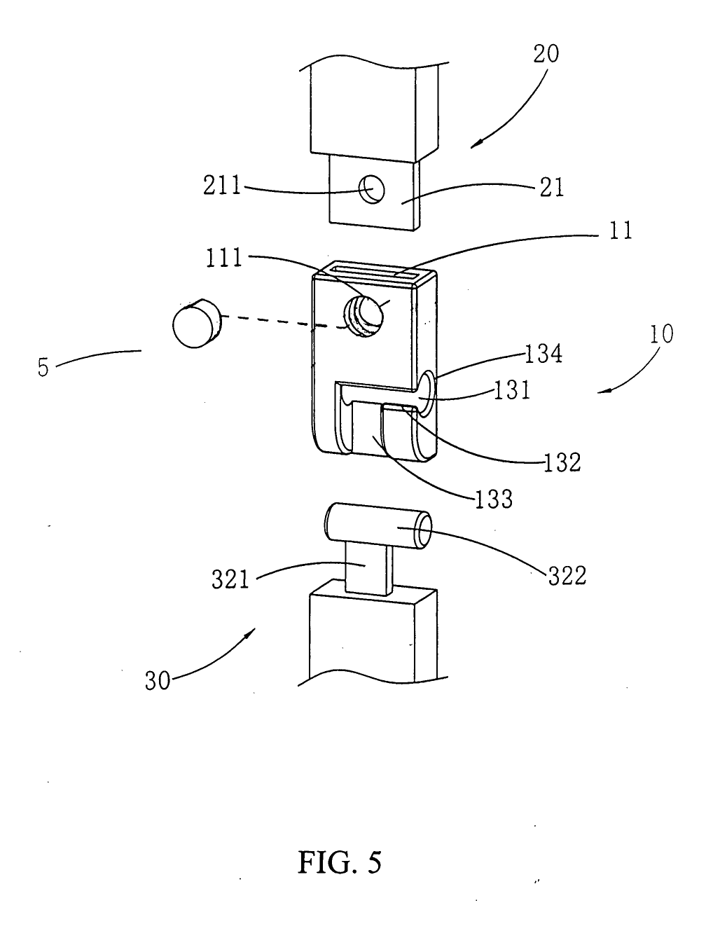

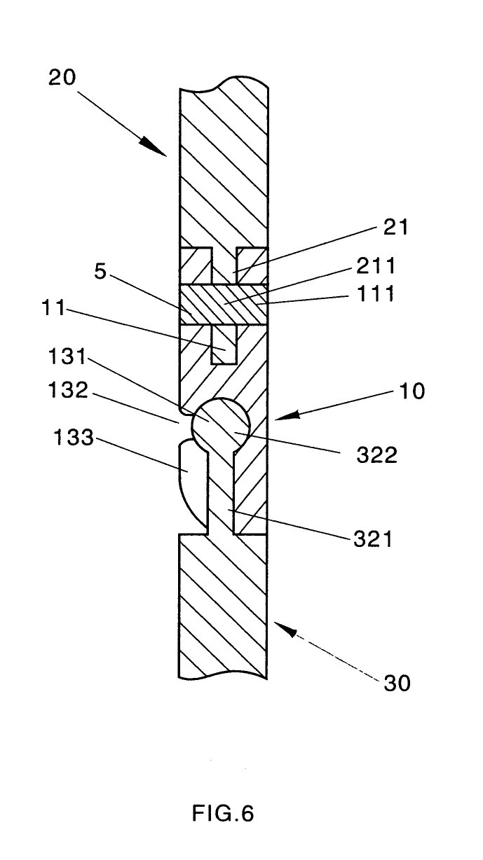

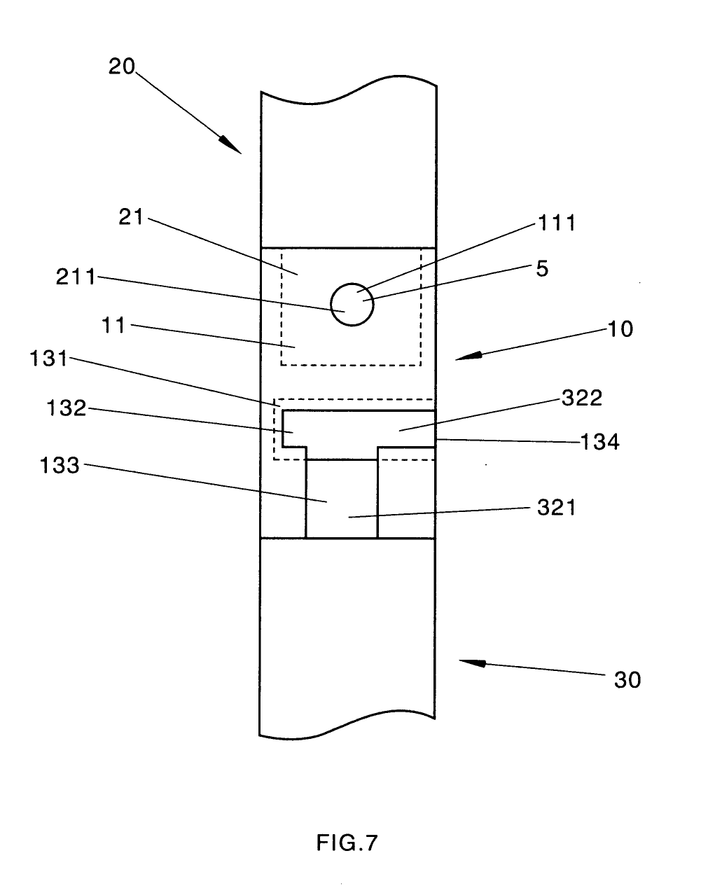

Referring to FIGS. 5, 6 and 7, a second preferred embodiment of the present invention is illustrated. A connector 20 is formed integrally extending from the temple portion 120, and connects to the locking mean 10, wherein the connector 20 has a flange 21 which is extended from the end of the connector 20, and the locking mean 10 further has a receiving chamber 11 which is formed on one end of the locking mean 10 for receiving the flange 21. Moreover, the flange 21 is consistent with the shape and the size to the receiving chamber 11, at least one locking hole 111 is located on the side of the locking mean 10 perpendicular to the receiving chamber 11, and at least one fixing hole 211 is located on the flange 21 corresponding to the location of the locking hole 111, and the fixing hole 211 has same diameter with the locking hole 111, when the flange 21 is inserted into the receiving chamber 11, the fixing hole 211 and the locking hole 111 will be overlapped.

In order to fasten the connector 20 to the locking mean 10, the locking mean 10 further has a fastener 5, and the size and the shape of the fastener 5 are matched to the locking hole 111, so that the fastener 5 can be perfectly fitted into the overlapped hole of the fixing hole 211 and the locking hole 111.

Preferably, the fastener 5 is made of a resilient material, and the diameter of fastener 5 is slightly greater than the diameter of the overlapped hole. When the flange 21 is inserted into the receiving chamber 11, the fastener 5 can be as a pin locked into overlap holes of the fixing hole 211 and the locking hole 111, so as to securely fasten the connector 20 to the locking mean 10, and also by removing the fastener 5, the connector 20 and the locking mean 10 can be detached easily as well. In actual production, the fastener 5 can be a regular metal screw for connecting two components of the connector 20 and the locking mean 10.

It is worth to mention some different alternative modes of connectors, the connector 20 can be formed integrally extending from the end-piece portion 110 instead of extending from the temple portion 120, and also the connector 20 has a receiving chamber instead of having a flange while the locking mean 10 has a flange. Furthermore, the above mentioned connectors can be placed in the connecting mean 30, or two above mentioned connectors are placed in the locking mean 10 and the connecting mean 30 respectively.

The above descriptions are used to expose the present invention to enable those skilled in the art to practice the invention. One skilled in the art will understand that the embodiment of the present invention as shown in the drawings and described above is exemplary only and subject to change without departing from such principles. Therefore, this invention includes all modifications encompassed within the spirit and scope of the following claims.

1-11. (canceled)

12. A detachable hinge for connecting between an end-piece portion and a temple portion of a spectacle frame, comprising:
a connecting means which comprises a first connecting member arranged for being extended from the temple portion, and a second connecting member extended from said second first connecting member; and
a locking means arranged for connecting to the end-piece, wherein said locking means has a vertical hole formed on a top side of said locking means and extended downwardly to near a bottom side thereof, a vertical slot formed at an inner side of said locking means to communicate with said vertical hole, and a horizontal slot extended from an end of said vertical slot to receive said first connecting member when said second connecting member is received in said vertical hole, wherein said vertical hole and said vertical slot are constructed to form a locking slot, wherein said second connecting member is slid into said vertical hole from said top side of said locking means to enable said second connecting member to be rotated within said vertical hole so as to detachably couple said locking means with said connecting means, wherein once said locking means is coupled with said connecting means, said locking means is prohibited to be detached from said connecting means unless said second connecting member is rotated within said vertical hole to align said first connecting with said vertical slot.

13. The detachable hinge, as recited in claim 12, wherein said vertical slot is cut through said inner side of said locking means to communicate with said vertical hole.

14. The detachable hinge, as recited in claim 12, wherein said second connecting member has a cylindrical shape, and a width of said second connecting member is larger than that of said first connecting member.

15. The detachable hinge, as recited in claim 12, wherein said first connecting member has a cuboid shape and is biased against a wall of said horizontal slot for blocking said first connecting member from being over turned when said second connecting member is rotated within said vertical hole.

16. The detachable hinge, as recited in claim 12, wherein a width of said vertical slot is smaller than a diameter of said vertical hole.

17. The detachable hinge, as recited in claim 12, wherein said locking means is made of resilient material and said connecting means is made of metal or resilient material.

18. A spectacle frame, comprising:
an end-piece portion;
a temple portion; and
a detachable hinge for connecting between said end-piece portion and said temple portion, comprising:
a connecting means which comprises a first connecting member extended from said temple portion, and a second connecting member extended from said second first connecting member; and
a locking means extended from said end-piece, wherein said locking means has a vertical hole formed on a top side of said locking means and extended downwardly to near a bottom side thereof, a vertical slot formed at an inner side of said locking means to communicate with said vertical hole, and a horizontal slot extended from an end of said vertical slot to receive said first connecting member when said second connecting member is received in said vertical hole, wherein said vertical hole and said vertical slot are constructed to form a locking slot, wherein said second connecting member is slid into said vertical hole from said top side of said locking means to enable said second connecting member to be rotated within said vertical hole so as to detachably couple said locking means with said connecting means, wherein once said locking means is coupled with said connecting means, said locking means is prohibited to be detached from said connecting means unless said second connecting member is rotated within said vertical hole to align said first connecting with said vertical slot.

19. The spectacle frame, as recited in claim 18, wherein said vertical slot is cut through said inner side of said locking means to communicate with said vertical hole.

20. The spectacle frame, as recited in claim 18, wherein said second connecting member has a cylindrical shape, and a width of said second connecting member is larger than that of said first connecting member.

21. The spectacle frame, as recited in claim 19, wherein said second connecting member has a cylindrical shape, and a width of said second connecting member is larger than that of said first connecting member.

22. The spectacle frame, as recited in claim 18, wherein said first connecting member has a cuboid shape and is biased against a wall of said horizontal slot for blocking said first connecting member from being over turned when said second connecting member is rotated within said vertical hole.

23. The spectacle frame, as recited in claim 21, wherein said first connecting member has a cuboid shape and is biased against a wall of said horizontal slot for blocking said first connecting member from being over turned when said second connecting member is rotated within said vertical hole.

24. The spectacle frame, as recited in claim 18, further comprising a fastener and a flange, having a fixing hole, integrally extended from said end-piece portion, wherein said locking means further has a receiving chamber formed at one end of said locking means that receives said flange therein and a locking hole overlapped and aligned with said fixing hole when said flange is inserted into said receiving chamber, such that said fastener is detachably fitted into said locking hole and said fixing hole to lock up said locking means to said end-piece portion.

25. The spectacle frame, as recited in claim 23, further comprising a fastener and a flange, having a fixing hole, integrally extended from said end-piece portion, wherein said locking means further has a receiving chamber formed at one end of said locking means that receives said flange therein and a locking hole overlapped and aligned with said fixing hole when said flange is inserted into said receiving chamber, such that said fastener is detachably fitted into said locking hole and said fixing hole to lock up said locking means to said end-piece portion.

26. The spectacle frame, as recited in claim 18, further comprising a fastener and a flange, having a fixing hole, integrally extended from said locking means, wherein said end-piece portion further has a receiving chamber formed at one end of said end-piece that receives said flange therein and a locking hole overlapped and aligned with said fixing hole when said flange is inserted into said receiving chamber, such that said fastener is detachably fitted into said locking hole and said fixing hole to lock up said locking means to said end-piece portion.

27. The spectacle frame, as recited in claim 24, further comprising a fastener and a flange, having a fixing hole, integrally extended from said locking means, wherein said end-piece portion further has a receiving chamber formed at one end of said end-piece that receives said flange therein and a locking hole overlapped and aligned with said fixing hole when said flange is inserted into said receiving chamber, such that said fastener is detachably fitted into said locking hole and said fixing hole to lock up said locking means to said end-piece portion.

28. The spectacle frame, as recited in claim 25, wherein a size and shape of said fixing hole is identical to a size and shape of said locking hole.

29. The spectacle frame, as recited in claim 27, wherein a size and shape of said fixing hole is identical to a size and shape of said locking hole.

30. The spectacle frame, as recited in claim 25, wherein said fastener is made of resilient material, wherein a diameter of said fastener is slightly larger than a diameter of each of said fixing hole and said locking hole.

31. The spectacle frame, as recited in claim 27, wherein said fastener is made of resilient material, wherein a diameter of said fastener is slightly larger than a diameter of each of said fixing hole and said locking hole.
